(19) United States
(12) Patent Application Publication
(10) Pub. No.: US 2016/0159671 A1
(43) Pub. Date: Jun. 9, 2016

(54) METHOD AND APPARATUS FOR TREATING WATER CONTAINING BORON

(71) Applicant: KURITA WATER INDUSTRIES LTD., Tokyo (JP)

(72) Inventor: Nozomu IKUNO, Tokyo (JP)

(73) Assignee: Kurita Water Industries Ltd., Nakano-ku, Tokyo (JP)

(21) Appl. No.: 14/906,419

(22) PCT Filed: Jun. 25, 2014
(86) PCT No.: PCT/JP2014/066864

§ 371 Date: Jan. 20, 2016

(30) Foreign Application Priority Data
Jul. 22, 2013 (JP) 2013-151701

(51) Int. Cl. C02F 9/00; C02F 1/52; B01D 61/58; C02F 1/461; B01D 61/02; B01D 61/44; C02F 1/44; C02F 1/42

(52) U.S. Cl. CPC C02F 9/00; C02F 1/441; C02F 1/52; C02F 1/42; C02F 1/444; C02F 1/461; B01D 61/025; B01D 61/44; B01D 61/58; C02F 2101/108

(57) ABSTRACT

A method and an apparatus for treating water containing boron that enable boron to be removed from water containing boron with efficiency by using an RO device and an ion-exchange device in the acidic to neutral pH range in which an RO film has high resistance to degradation are provided. A method for treating water containing boron, comprising: a step in which water containing boron is passed through a high-pressure reverse osmosis membrane device; and a step in which the water passed through the device is subsequently treated by an ion-exchange device. An apparatus for treating water containing boron comprising: a high-pressure reverse osmosis membrane device into which water containing boron is fed; and an ion-exchange device through which water that permeated through the high-pressure reverse osmosis membrane device is passed.

### FIELD OF THE INVENTION

The present invention relates to a method and an apparatus for treating water containing boron and particularly relates to a method and an apparatus for treating water containing boron by using a reverse osmosis membrane device (hereinafter, may be referred to as “RO device”) and an ion-exchange device, which may be suitably employed in a primary pure water system or a recovery system included in an ultrapure water production apparatus.

### BACKGROUND OF THE INVENTION

An ultrapure water production system generally includes a pretreatment system, a primary pure water system, a subsystem, and, as needed, a recovery system. The pretreatment system includes a clarification treatment device in which coagulation filtration, an MF membrane (microfiltration membrane), a UF membrane (ultrafiltration membrane), or the like is used and a dechlorination treatment device in which activated carbon or the like is used.

The primary pure water system includes an RO membrane (reverse osmosis membrane) device, a deaeration membrane device, an ion-exchange tower, and the like. The primary pure water system removes most of the ion components and the TOC component.

The recovery system is a system for treating water (used ultrapure water) discharged from a use point such as a semiconductor-cleaning process. The recovery system includes a biological treatment device, a coagulation device, a floatation or settlement device, a filtration device, an RO membrane (reverse osmosis membrane) device, and an ion-exchange tower.

The subsystem includes a UV device (ultraviolet oxidation device), a nonregenerative ion-exchange device, a UF device (ultrafiltration device), and the like. The subsystem removes trace ions, in particular, trace organic substances having a low molecular weight, and fine particles. Ultrapure water produced in the subsystem is fed to the use point and an excess portion of the ultrapure water is generally returned to a tank disposed upstream of the subsystem.

In the subsystem, trace ions are removed using a nonregenerative ion-exchange resin tower packed with an ion-exchange resin. The ion-exchange resin is replaced at a frequency of about once or twice a year. However, when the pure water treated in the subsystem contains boron, the service life of the ion-exchange resin becomes short (e.g., about two weeks) since the amount of boron that can be adsorbed by an anion-exchange resin is small, that is, about 1/1000 the amount of general ions that can be adsorbed by the anion-exchange resin. Therefore, it is necessary to remove boron in the primary pure water system and the recovery system.

Boron contained in water can be removed by, for example, a reverse osmosis membrane separation method (RO method) or an ion-exchange method (anion-exchange resin or chelate resin). RO enables removal of impurities contained in water, such as desalination and removal of organic substances, to be achieved with efficiency. However, since the dissociation of boron occurs only slightly in water, a boron rejection achieved using RO is low, that is, about 60% to 70% in the neutral range. In an ion-exchange method in which an anion-exchange resin is used, regeneration may be performed at a considerably high frequency since the amount of boron that can be adsorbed by an anion-exchange resin is only about 1/1000 the amount of general ions that can adsorb on the anion-exchange resin. Therefore, a treatment in the primary pure water system or the recovery system has been performed by using a plurality of regenerative ion-exchange towers (e.g., four beds and five towers+RO, or two beds and three towers+RO+mixed bed) including a single-bed or mixed-bed anion-exchange resin.

A chelate resin has a boron-adsorption capacity about ten times that of an anion-exchange resin. However, a method for regenerating a chelate resin is complex because it requires both acid and alkali chemicals to be used.

Controlling the pH of water containing boron to be alkaline increases a boron rejection achieved using RO. Patent literatures 1 to 3 describe a method for treating water containing boron in which an alkali is added to water containing boron, the water containing boron is subsequently subjected to an RO treatment using an alkali-resisting RO device, and then an ion-exchange treatment is performed.

However, when the pH of water containing boron is alkaline, hardness scale is likely to be precipitated on the surface of the RO membrane. Furthermore, even an alkali-resisting RO membrane gradually becomes degraded due to alkalinity. As a result, the frequency at which the RO membrane is replaced may be increased.

### LIST OF LITERATURE

### Patent Literature

Patent literature 1: Japanese Patent Publication 11-128921 A

Patent literature 2: Japanese Patent Publication 11-128923 A

Patent literature 3: Japanese Patent Publication 11-188359 A

### OBJECT AND SUMMARY OF THE INVENTION

### Object of the Invention

An object of the present invention is to provide a method and an apparatus for treating water containing boron that enable boron to be removed from water containing boron with efficiency by using an RO device and an ion-exchange device in the acidic to neutral pH range in which an RO film has high resistance to degradation.

### SUMMARY OF THE INVENTION

The gist of the present invention is as below:

[1] A method for treating water containing boron, comprising: a step in which water containing boron is passed through a high-pressure reverse osmosis membrane device; and a step in which the water passed through the device is subsequently treated by an ion-exchange device.

[2] The method for treating water containing boron according to [1], wherein the ion-exchange device includes any one of regenerative ion-exchange devices described in a) to e) below,

a) a single-bed, single-tower regenerative ion-exchange device packed with a strongly basic anion-exchange resin,

b) a two-bed, two-tower regenerative ion-exchange device including a cation-exchange resin tower packed with a strongly acidic cation-exchange resin and an anion-exchange resin tower packed with a strongly basic anion-exchange resin, the cation-exchange resin tower and the anion-exchange resin tower being connected to each other in series,

c) a two-bed, one-tower regenerative ion-exchange device including one ion-exchange resin tower in which a strongly acidic cation-exchange resin and a strongly basic anion-exchange resin are arranged to form independent layers,

d) a mixed-bed regenerative ion-exchange device including one tower packed with a strongly acidic cation-exchange resin and a strongly basic anion-exchange resin that are uniformly mixed together, and

e) a regenerative ion-exchange device including one or more electric regenerative deionizing apparatus connected to one another in series.

[3] The method for treating water containing boron according to [1] or [2], wherein the water containing boron is subjected to a coagulation treatment and a filtration treatment prior to being fed to the high-pressure reverse osmosis membrane device.

[4] The method for treating water containing boron according to any one of [1] to [3], wherein water fed to the high-pressure reverse osmosis membrane device has a pH of 5 to 8.

[5]An apparatus for treating water containing boron comprising: a high-pressure reverse osmosis membrane device into which water containing boron is fed; and an ion-exchange device through which water that permeated through the high-pressure reverse osmosis membrane device is passed.

[6] The apparatus for treating water containing boron according to [5], wherein the ion-exchange device includes any one of regenerative ion-exchange devices described in a) to e) below,

a) a single-bed, single-tower regenerative ion-exchange device packed with a strongly basic anion-exchange resin,

b) a two-bed, two-tower regenerative ion-exchange device including a cation-exchange resin tower packed with a strongly acidic cation-exchange resin and an anion-exchange resin tower packed with a strongly basic anion-exchange resin, the cation-exchange resin tower and the anion-exchange resin tower being connected to each other in series,

c) a two-bed, one-tower regenerative ion-exchange device including one ion-exchange resin tower in which a strongly acidic cation-exchange resin and a strongly basic anion-exchange resin are arranged to form independent layers,

d) a mixed-bed regenerative ion-exchange device including one tower packed with a strongly acidic cation-exchange resin and a strongly basic anion-exchange resin that are uniformly mixed together, and

e) a regenerative ion-exchange device including one or more electric regenerative deionizing apparatus connected to one another in series.

[7] The apparatus for treating water containing boron according to [5] or [6], the apparatus comprising a coagulation treatment device and a filtration device disposed upstream of the high-pressure reverse osmosis membrane device.

### Advantageous Effects of the Invention

In the method and apparatus for treating water containing boron according to the present invention, a high-pressure RO device is used as an RO device for treating water containing boron. The high-pressure RO device includes an RO membrane having a fine surface, which enables a high boron rejection to be achieved even in the neutral pH range. Since the concentration of boron in water discharged from the high-pressure RO device has been reduced to a considerably low level, it is possible to produce treated water having a boron concentration reduced to a sufficient degree only by using a single regenerative ion-exchange device disposed downstream of the high-pressure RO device.

### BRIEF DESCRIPTION OF DRAWINGS

FIG. 1 is a flow diagram of a method and an apparatus for treating water containing boron which were used in Examples.

### DESCRIPTION OF EMBODIMENTS

Water containing boron that is to be treated in the present invention may be natural raw water such as river water, well water, or lake water, water recovered from a semiconductor-manufacturing process, or water prepared by treating the recovered water. The method and the apparatus according to the present invention may be suitably used for removing boron from raw water in order to produce ultrapure water. The boron concentration in the raw water is preferably 10 to 100 μg/L and is particularly preferably about 20 to 50 μg/L.

In the present invention, water containing boron may optionally be subjected to a pretreatment as needed prior to being subjected to a high-pressure RO treatment. The pretreatment is preferably performed by using a method or an apparatus in which a flocculant is added to the water containing boron and filtration is subsequently performed. The flocculant is preferably an inorganic flocculant such as polyaluminium chloride, aluminium sulfate, ferric chloride, or ferric sulfate. In the filtration treatment subsequent to the coagulation treatment, various types of filters such as a sand filter and a dual-media filter containing sand and anthracite may be used. A membrane filter such as an MF membrane may also be used.

In the present invention, the raw water or water prepared by pretreating the raw water, that is, pretreated water, is treated using a high-pressure RO device. Water fed into the high-pressure RO device preferably has a pH of 5 to 8 and a TDS (total dissolved solids concentration) of 1500 mg/L or less. In order to remove boron at a higher level, the pH of the water fed into the high-pressure RO membrane device may be set to 9 to 11, that is, to be alkaline.

A high-pressure RO device is a reverse osmosis membrane separation device that has been used for desalination of sea water. A high-pressure RO device includes an RO membrane having a finer surface skin than a low-pressure or ultralow-pressure reverse osmosis membrane used in a primary pure water system included in the ultrapure water production apparatus of the related art. Therefore, a high-pressure reverse osmosis membrane has a higher boron rejection than a low-pressure or ultralow-pressure reverse osmosis membrane although the flow rate of water that permeates through the high-pressure reverse osmosis membrane per unit operation pressure is lower than the flow rate of water that permeates through the low-pressure or ultralow-pressure reverse osmosis membrane per unit operation pressure.

In the high-pressure RO membrane device, as described above, the flow rate of water that permeates through the membrane per unit operation pressure is low. The high-pressure RO membrane device has a pure water permeate flux of 0.6 to 1.3 m³/m²/day and a NaCl rejection of 99.5% or more under an effective pressure of 2.0 MPa at 25° C. The effective pressure is an effective pressure applied to the membrane, which is determined by subtracting a difference in osmotic pressure and a secondary-side pressure from the average operation pressure. The NaCl rejection is a rejection determined at 25° C. under an effective pressure of 2.7 MPa using an aqueous NaCl solution having a NaCl concentration of 32000 mg/L.

In the present invention, water that permeated through the high-pressure RO device is further subjected to an ion-exchange treatment. The ion-exchange treatment is performed using a nonregenerative ion-exchange device and/or a regenerative ion-exchange device. In the present invention, using any one of the nonregenerative ion-exchange device and the regenerative ion-exchange device alone is enough since large part (e.g., 95% or more) of boron has been removed in the high-pressure RO device and the boron concentration in water subjected to the ion-exchange treatment is about 0.5 to 8 μg/L. However, in order to remove boron and/or other ionic substances to a sufficient degree with consistency, it is preferable to dispose a regenerative ion-exchange device or a nonregenerative ion-exchange device, and a nonregenerative ion-exchange device downstream of the regenerative ion-exchange device or the nonregenerative ion-exchange device. In order to remove boron and other ionic substances with efficiency, it is more preferable to dispose a regenerative ion-exchange device and a nonregenerative ion-exchange device downstream of the regenerative ion-exchange device.

In order to remove boron that remains in water treated in the high-pressure RO membrane device, the regenerative ion-exchange device needs to be any one of an ion-exchange tower packed with at least a strongly basic anion-exchange resin or a boron-selective resin (e.g., boron chelate resin) and an electrical regenerative deionization exchange device.

The ion-exchange tower packed with a strongly basic anion-exchange resin may be a single-bed, single-tower ion-exchange device including a single anion-exchange resin tower packed with a strongly basic anion-exchange resin only in the case where the substance to be removed is boron only. However, in general, it is also necessary to remove cationic substances. Thus, the following two-bed, two-tower method, two-bed, one-tower method, and mixed-bed method are preferably employed.

Two-bed, two-tower method: a method in which a treatment is performed using a cation-exchange resin tower packed with a strongly acidic cation-exchange resin and an anion-exchange resin packed with a strongly basic anion-exchange resin, the cation-exchange resin tower and the anion-exchange resin being connected to each other in series.

Two-bed, one-tower method: a method in which a treatment is performed using one ion-exchange resin tower in which a strongly acidic cation-exchange resin and a strongly basic anion-exchange resin are arranged to form independent layers.

Mixed-bed method: a method in which a treatment is performed using one tower packed with a strongly acidic cation-exchange resin and a strongly basic anion-exchange resin that are uniformly mixed together.

The electrical regenerative deionization device may be an electric deionizing apparatus including an anode, a cathode, and alternating pairs of a concentration compartment and a desalination compartment defined by a plurality of anion-exchange membranes and cation-exchange membranes arranged alternately, the desalination compartment being packed with an ion exchanger such as a mixed ion-exchange resin including an anion-exchange resin and a cation-exchange resin or ion-exchange fibers. An electric deionizing apparatus including concentration compartments packed with an ion exchanger may also be used.

The nonregenerative ion-exchange device used in the present invention is preferably a nonregenerative ion-exchange device used in ultrapure water production equipment. The nonregenerative ion-exchange device is preferably packed with at least a strongly basic anion-exchange resin or a boron-selective resin (e.g., boron chelate resin). In particular, a single-bed, single-tower nonregenerative ion-exchange device including one tower packed with a boron-selective resin and a nonregenerative ion-exchange device packed with a strongly acidic cation-exchange resin and a strongly basic anion-exchange resin that are mixed together or that are arranged to form independent layers are preferably used. The nonregenerative ion-exchange device does not include regeneration equipment inside the device. Thus, when the treatment capacity of the nonregenerative ion-exchange device becomes low, the ion-exchange resin charged in the nonregenerative ion-exchange device is not regenerated but replaced with another ion-exchange resin that has been regenerated in another place.

In the case where the single-bed, single-tower nonregenerative ion-exchange device including a boron-selective resin is used, it is preferable to dispose a nonregenerative ion-exchange tower downstream of the single-bed, single-tower nonregenerative ion-exchange device in order to remove other ionic substances, the nonregenerative ion-exchange tower being packed with a strongly acidic cation-exchange resin and a strongly basic anion-exchange resin that are mixed together or that are arranged to form independent layers.

In the case where a treatment is performed using the nonregenerative ion-exchange tower packed with a strongly acidic cation-exchange resin and a strongly basic anion-exchange resin that are mixed together or that are arranged to form independent layers, it is possible to remove organic substances by disposing an ultraviolet oxidation device upstream of the nonregenerative ion-exchange tower.

In the case where water fed into the RO device has a pH of about 5 to 8, the pH of water that permeated through the RO device is reduced to be slightly acidic since alkaline components are removed in the RO device. Therefore, water that permeated through the high-pressure RO device may be subjected to a decarboxylation treatment in which deaeration is performed using a membrane deaeration device, a vacuum deaeration device, or the like prior to being treated using the ion-exchange device. In the present invention, an acid may be added to the pretreated water in order to perform deaeration prior to the high-pressure RO treatment.

In the present invention, water that permeated through the high-pressure RO device may be treated using another RO device or water that permeated through another RO membrane device may be treated using the high-pressure RO device prior to being treated in the ion-exchange device. The other RO device may be a high-pressure RO device or a low-pressure or ultralow-pressure reverse osmosis membrane device used in the primary pure water system of the related art.

In the present invention, concentrate water produced in the high-pressure RO device (hereinafter, may be referred to as “first high-pressure RO device”) may be treated in an optional second high-pressure RO device and water that permeated through the second high-pressure RO device may be returned to the first high-pressure RO device as feedwater in order to increase a water recovery percentage.

The method and the apparatus for treating water containing boron according to the present invention are preferably applied to a primary pure water system and a recovery system included in an ultrapure water production system. Thus, water containing boron which has been treated using the method and the apparatus for treating water containing boron according to the present invention is preferably treated in a subsystem including a UV device (ultraviolet oxidation device), a nonregenerative ion-exchange device, a UF device (ultrafiltration device), and the like.

### EXAMPLES

### Example 1

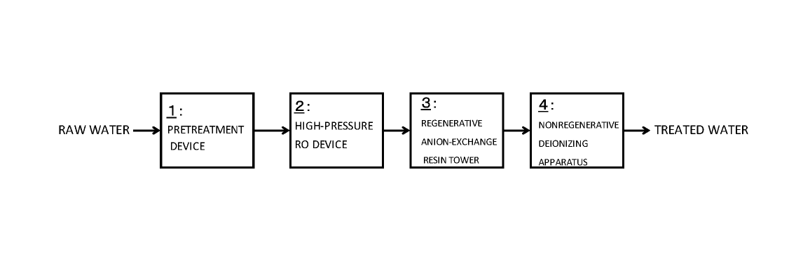

Industrial water having a boron concentration of 100 μg/L, a TDS of 500 mg/L, a pH of 6.5, and an electric conductivity of 32 mS/m was treated in accordance with the procedure illustrated in FIG. 1. The industrial water was subjected to a coagulation treatment, a filtration treatment, and a membrane treatment in a pretreatment device 1. The flocculant used in the coagulation treatment was 10 mg/L of polyaluminium chloride. The filtration treatment was performed using a sand-anthracite dual-media filter. The resulting pretreated water had a pH of 6.

The pretreated water was treated in a high-pressure RO device 2 (SWC4Max produced by Nitto Denko Corporation, pure water permeate flux [at effective pressure: 2.0 MPa, and temperature: 25° C.]: 0.78 m³/m²/day; NaCl rejection [at effective pressure: 2.0 MPa, temperature: 25° C., NaCl concentration: 32000 mg/L]: 99.8%) at a recovery percentage of 75%. Water that permeated through the high-pressure RO device was passed through a regenerative anion-exchange resin tower 3 packed with an anion-exchange resin (Monosphere550A(H) produced by Dow Chemical Company) at an SV of 30 and subsequently passed through a nonregenerative deionizing apparatus 4 at an SV of 50. The boron concentration in the water was measured 24 hours after the initiation of water-passing operation in each step. Table 1 summarizes the results. In Table 1, water that had been treated in the nonregenerative deionizing apparatus 4 is abbreviated to “Nonregenerative treated water”.

### Comparative Example 1

A treatment was performed same as in Example 1, except that an ultralow-pressure RO device including an ultralow-pressure RO membrane (ES-20 produced by Nitto Denko Corporation) was used instead of the high-pressure RO device. The boron concentration in the water was measured in each step. Table 1 summarizes the results.

### Comparative Example 2

The same raw water as used in Example 1 was pretreated under the same conditions as in Example 1. The resulting pretreated water was passed into a first cation-exchange resin tower at an SV of 30. Water (pH: 2) discharged from the first cation-exchange resin tower was subjected to a decarboxylation treatment using a membrane deaeration device. The resulting deaerated water was passed into a first anion-exchange resin tower at an SV of 30, subsequently passed into a second cation-exchange resin tower at an SV of 100, then passed into a second anion-exchange resin tower at an SV of 100, and subsequently passed into a nonregenerative anion-exchange resin tower at an SV of 50. The boron concentration in the water was measured in each step. Table 1 summarizes the results.

TABLE 1

| | | Regenerative | |
|---|---|---|---|
| | High-pressure | ion-exchange | Nonregenerative |
| | RO treated water | treated water | treated water |
| Example 1 | 5 μg/L | <1 ng/L | <1 ng/L |

| | Ultralow- | Regenerative | |
|---|---|---|---|
| | pressure RO | ion-exchange | Nonregenerative |
| | treated water | treated water | treated water |
| Comparative | 60 μg/L | 3 μg/L | <1 ng/L |
| example 1 | | | |

| | First cation- | First anion- | Second cation- | Second anion- | |
|---|---|---|---|---|---|
| | exchange resin | exchange | exchange resin | exchange resin | |
| | tower treated | resin tower | tower treated | tower treated | Nonregenerative |
| | water | treated water | water | water | treated water |
| Comparative | 100 μg/L | 5 μg/L | 5 μg/L | <1 ng/L | <1 ng/L |
| example 2 | | | | | |

As shown in Table 1, in Example 1 where a high-pressure RO device was used, water that permeated RO had a low boron concentration of 5 μg/L and water treated in the regenerative anion-exchange resin tower had a sufficiently low boron concentration of 1 ng/L or less. In Comparative example 1 where an ultralow-pressure RO device (ES-20 produced by Nitto Denko Corporation, pure water permeate flux [effective pressure: 2.0 MPa, temperature: 25° C.]: 1 m³/m²/day; NaCl rejection [effective pressure: 0.75 MPa, temperature: 25° C., NaCl concentration: 500 mg/L]: 99.7%) was used instead of the high-pressure RO device, water that permeated the RO device had a high boron concentration of 60 μg/L and water treated in the regenerative anion-exchange resin tower had a high boron concentration of 3 μg/L.

Although the present invention has been described in detail with reference to a particular embodiment, it is apparent to a person skilled in the art that various modifications can be made therein without departing from the spirit and scope of the present invention.

The present application is based on Japanese Patent Application No. 2013-151701 filed on Jul. 22, 2013, which is incorporated herein by reference in its entirety.

1. A method for treating water containing boron, comprising:
a step in which water containing boron is passed through a high-pressure reverse osmosis membrane device; and
a step in which the water passed through the device is subsequently treated by an ion-exchange device.

2. The method for treating water containing boron according to claim 1, wherein the ion-exchange device includes any one of regenerative ion-exchange devices described in a) to e) below,
a) a single-bed, single-tower regenerative ion-exchange device packed with a strongly basic anion-exchange resin,
b) a two-bed, two-tower regenerative ion-exchange device including a cation-exchange resin tower packed with a strongly acidic cation-exchange resin and an anion-exchange resin tower packed with a strongly basic anion-exchange resin, the cation-exchange resin tower and the anion-exchange resin tower being connected to each other in series,
c) a two-bed, one-tower regenerative ion-exchange device including one ion-exchange resin tower in which a strongly acidic cation-exchange resin and a strongly basic anion-exchange resin are arranged to form independent layers,
d) a mixed-bed regenerative ion-exchange device including one tower packed with a strongly acidic cation-exchange resin and a strongly basic anion-exchange resin that are uniformly mixed together, and
e) a regenerative ion-exchange device including one or more electric regenerative deionizing apparatus connected to one another in series.

3. The method for treating water containing boron according to claim 1, wherein the water containing boron is subjected to a coagulation treatment and a filtration treatment prior to being fed to the high-pressure reverse osmosis membrane device.

4. The method for treating water containing boron according to claim 1, wherein water fed to the high-pressure reverse osmosis membrane device has a pH of 5 to 8.

5. An apparatus for treating water containing boron comprising:
a high-pressure reverse osmosis membrane device into which water containing boron is fed; and
an ion-exchange device through which water that permeated through the high-pressure reverse osmosis membrane device is passed.

6. The apparatus for treating water containing boron according to claim 5, wherein the ion-exchange device includes any one of regenerative ion-exchange devices described in a) to e) below,
a) a single-bed, single-tower regenerative ion-exchange device packed with a strongly basic anion-exchange resin,
b) a two-bed, two-tower regenerative ion-exchange device including a cation-exchange resin tower packed with a strongly acidic cation-exchange resin and an anion-exchange resin tower packed with a strongly basic anion-exchange resin, the cation-exchange resin tower and the anion-exchange resin tower being connected to each other in series,
c) a two-bed, one-tower regenerative ion-exchange device including one ion-exchange resin tower in which a strongly acidic cation-exchange resin and a strongly basic anion-exchange resin are arranged to form independent layers,
d) a mixed-bed regenerative ion-exchange device including one tower packed with a strongly acidic cation-exchange resin and a strongly basic anion-exchange resin that are uniformly mixed together, and
e) a regenerative ion-exchange device including one or more electric regenerative deionizing apparatus connected to one another in series.

7. The apparatus for treating water containing boron according to claim 5, the apparatus comprising a coagulation treatment device and a filtration device disposed upstream of the high-pressure reverse osmosis membrane device.
